(19) United States
(12) Patent Application Publication
(10) Pub. No.: US 2011/0239178 A1
(43) Pub. Date: Sep. 29, 2011

(54) LAYOUT DESIGN APPARATUS, LAYOUT DESIGN METHOD, AND COMPUTER READABLE MEDIUM HAVING A LAYOUT DESIGN PROGRAM

(75) Inventor: Ryoichi YAMASHITA, Kawasaki (JP)

(73) Assignee: FUJITSU LIMITED, Kawasaki (JP)

(21) Appl. No.: 12/947,331

(22) Filed: Nov. 16, 2010

(30) Foreign Application Priority Data
Mar. 25, 2010 (JP) 2010-69329

(51) Int. Cl. G06F 17/50

(52) U.S. Cl. 716/122

(57) ABSTRACT

A layout design apparatus that designs a layout of a semiconductor integrated circuit having a plurality of layers, the apparatus includes an extractor configured to extract, when given a lower module used at multiple locations inside an upper module, information regarding upper layer wiring near respective placement locations where the lower module is placed, and a layout design unit configured to lay out the lower module by setting prohibited wiring regions in a layout database based on the upper layer wiring information extracted from multiple locations. The prohibited wiring regions are specific regions that prohibit wiring processes therein, and the layout database is data for laying out the lower module.

### CROSS-REFERENCE TO RELATED APPLICATION

This application is based upon and claims the benefit of priority of the prior Japanese Patent Application No. 2010-69329, filed on Mar. 25, 2010, the entire contents of which are incorporated herein by reference.

### FIELD

The embodiments discussed herein are related to a layout design of a semiconductor integrated circuit having multiple layers.

### BACKGROUND

Along with increases in the scale and density of semiconductor integrated circuits in recent years, size of design data has also become larger, and it is becoming difficult to lay out an entire circuit at once. For this reason, hierarchical design is conducted, where the entire circuit is segmented into a plurality of function modules, and where the logic design, layout design, and timing design then proceeds on a per-module basis. Finally, the function modules are integrated to the semiconductor integrated circuit as a whole.

When conducting hierarchical design, there may be cases of mutual influence between the wiring in an upper part and module boundary regions of a lower module, and the wiring in an upper layer. Herein, “influence” refers to the effects of factor(s) such as design rule violations in the layout design, and cross-talk noise. The word “influence” will be used in this sense hereinafter. For this reason, several technologies have been proposed for preventing such mutual influence between the wiring inside a lower module and the wiring in an upper layer.

A first technology proposes a technique of providing prohibited wiring regions of predetermined width near the boundaries of lower modules. For example, as illustrated in FIG. 17A, a circuit 26 is designed with a hierarchical layout so as to be functionally and physically segmented into two lower modules 35 and 36. In this case, a shield region (or in other words, a prohibited wiring region) of fixed width is provided near the inner or outer boundaries of each lower module 35 and 36, like the shaded regions in FIG. 17B. By providing prohibited wiring regions at the boundary parts of the lower modules in this way, the wiring patterns Net1 and Net2 inside the lower modules and the wiring pattern NetB inside the upper module can be prevented from influencing each other.

A second technology proposes a technique of designing the layout of an upper layer by extracting wiring information near the boundaries inside a lower module, and then setting prohibited wiring regions in the upper layer based on the extracted wiring information. For example, respective information may be extracted for the wiring Net1 near the module boundary inside the lower module 35, and for the wiring Net2 near the module boundary inside the lower module 36, as illustrated in FIG. 17C. Prohibited wiring regions may then be set in the upper layer based on the respectively extracted wiring information. The upper module 26 in the upper layer may then be laid out while taking into account information regarding the prohibited wiring regions thus set. In doing so, it becomes possible to design the layout of the upper module 26 while taking into account the wiring conditions inside the lower modules 35 and 36.

A third technology proposes a technique of designing the layout of lower modules by setting prohibited wiring regions inside the lower modules based on wiring information regarding the upper layer. For example, when laying out lower modules in a status where information regarding the wiring in an upper layer exists, the lower modules may be laid out by setting prohibited wiring regions within the lower modules based on information regarding upper layer wiring that passes through locations where the lower modules are placed. In doing so, it becomes possible to design the layout of the lower modules while taking into account the upper layer wiring existing near the lower modules.

Related arts described above are disclosed in Japanese Laid-open Patent Publication No. 2002-270775, Japanese Laid-open Patent Publication No. 2005-63275, Japanese Laid-open Patent Publication No. 2003-242191, and Japanese Laid-open Patent Publication No. 2002-289693.

In semiconductor integrated circuits intended for performance equipment such as high-end servers, manual layout is conducted in addition to automatic wiring using computer-aided design (CAD) tools, and efforts are made to design fast, high-density layouts. When designing fast, high-density hierarchical layouts for semiconductor integrated circuits, cases might occur when it is not easy to achieve high-quality layouts with the technologies described above. This issue is hereinafter described in detail.

When providing prohibited wiring regions of predetermined widths near the boundaries of lower modules as in the first technology described earlier, the prohibited wiring regions are set without taking into account the actual layout and wiring conditions of the circuit. For this reason, wiring may be prohibited even in regions where it is unnecessary to set a prohibited wiring region, thereby impeding the circuit integration with high density.

In the second technology, wiring information regarding the upper module 26 is not referenced when designing the lower modules 35 and 36. For this reason, in the second technology, the wiring in the upper module is preferably to be processed so as to avoid the wiring inside the lower modules 35 and 36 after the lower modules 35 and 36 have been designed, even in cases where clock wiring of the upper module 26 is supposed to be performed preferentially.

In the third technology, the layout of the lower modules is designed by taking into account the upper layer wiring near specific locations where the lower modules are placed. However, in this case, problems might arise when applying lower modules with wiring laid out in this way to multiple locations. Particularly, consider the case where the same lower module is to be placed in multiple locations, and furthermore where the wiring conditions surrounding the lower module differ at each placement location. In this case, there is a possibility that the layout of the lower module will need to be changed to match the wiring conditions surrounding the lower module at each respective placement location. In such cases, it becomes difficult to use a simple layout process flow to lay out the lower modules while taking into account the surrounding wiring conditions at all placement locations. Such conditions will now be described with the use of FIG. 18.

In FIG. 18, a semiconductor integrated circuit chip 27 includes the following lower modules: four circuit modules A (37, 38, 39 and 40), and one circuit module B (41). In FIG. 18, the black square drawn inside the frame of each lower module indicates the placement origin for that module. In other words, each black square indicates the reference position when executing layout processing for each lower module. The lower modules A are indicated with four instances (A1, A2, A3 and A4), and are placed in four locations and rotated in different directions. The lower module 38 and the lower module 39 are placed by rotating the lower module 37 to the right by 90 degrees, while the lower module 40 is placed by rotating the lower module 37 to the left by 90 degrees. Each of the lower modules 37 to 40 are taken to include an internal terminal, PinC, indicated as a black circle in FIG. 18. Each terminal PinC is connected to the lower module 41 by respectively different wiring patterns (NetA to NetD) in an upper layer. For the sake of convenience in this explanation, other terminals and wiring have been omitted from illustration in FIG. 18.

Designing the layout of the chip 27 illustrated in FIG. 18 may proceed as follows. For example, the design may first focus on the lower module 37 at the instance A1, and the placement, wiring, and other features of the layout of the lower module A may be designed while taking into account the upper layer wiring near the lower module 37, such as NetB, for example. In this case, the lower module A is laid out without taking into account the wiring conditions surrounding the lower modules 38, 39 and 40 at the other instances (A2, A3 and A4). In order to favorably use the lower module A laid out in this way at the respective locations of the instances A2, A3, and A4, it is preferable that the upper layer wiring near each of the lower modules 38, 39 and 40 at the instances A2, A3 and A4 be similar to the upper layer wiring near the lower module 37 at the instance A1.

However, depending on the layout and wiring conditions surrounding each lower module, asymmetry in the upper layer wiring may be unavoidable in particular parts, and in some cases it may be difficult to design the layout of the wiring near the respective lower modules 38, 39 and 40 in an identical state to the wiring near the lower module 37. For example, in FIG. 18, the individual nets (NetA, NetB, NetC, and NetD) are connected to the respective terminals PinC of the lower modules 37, 38, 39 and 40. In order to connect these nets (NetA, NetB, NetC, and NetD) to the central lower module 41 with a minimum connection length, it is necessary to use wiring that passes through different locations over each of the lower modules 37, 38, 39 and 40.

In cases where there is unavoidable asymmetry in the upper layer wiring near the respective lower modules 38, 39 and 40 versus the upper layer wiring near the lower module 37, the lower module A is first laid out using the lower module 37 as a reference, for example. Subsequently, the layout data for the laid out lower module A is applied to the lower modules 38, 39 and 40 at the instances A2, A3 and A4, and the placement locations of the respective lower modules 38, 39 and 40 are checked to determine whether or not any influence exists between the modules and the upper layer wiring or the wiring inside another module. If violations occur, then it becomes necessary to revise the upper layer wiring or revise the placement location and wiring of the affected lower modules A while taking into account the wiring conditions surrounding the lower modules A at the locations where violations occurred. Furthermore, it becomes necessary to once again check whether or not any violations have occurred.

Meanwhile, there is a problem in that, as the lower module A is reused and placed in an increasing number of locations, it becomes difficult to revise the lower module A while taking into account the upper layer wiring conditions near the lower module at all placement locations. For this reason, the present invention addresses the issue of designing the layout of a lower module when conducting hierarchical design of a semiconductor integrated circuit having multiple layers, wherein the lower module is designed while taking into account the upper layer wiring conditions near the lower module at each of a plurality of placement locations where the lower module is to be used.

### SUMMARY

A layout design apparatus that designs the layout of a semiconductor integrated circuit having a plurality of layers, the apparatus includes an extractor configured to extract, when given a lower module used at multiple locations inside an upper module, information regarding an upper layer wiring near the respective placement locations where the lower module is placed, and a layout design unit configured to lay out the lower module by setting prohibited wiring regions in a layout database based on information of the upper layer wiring extracted from the multiple locations, where the prohibited wiring regions are specific regions that prohibit wiring processes therein, and the layout database is data for laying out the lower module.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed. Additional aspects and/or advantages will be set forth in part in the description which follows and, in part, will be apparent from the description, or may be learned by practice of the invention.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an execution environment of a layout process in accordance with an embodiment;

FIG. 2 illustrates an example of an overall flow of a layout process in accordance with an embodiment;

FIG. 3A illustrates an example of wiring near a lower module placed at multiple locations;

FIG. 3B is a diagram for explaining a process for merging information regarding the wiring near a lower module placed at multiple locations illustrated in FIG. 3A into a single set of lower module layout data;

FIG. 4 illustrates an example of a case where a wiring inside adjacent lower modules are influencing each other;

FIG. 5 illustrates an example of a case where the same lower module is placed at multiple, adjacent locations;

FIG. 6 illustrates an example of extracting upper layer wiring information in a case where the same lower module is placed at multiple, adjacent locations;

FIG. 7 explains how to handle upper wiring connected to a terminal of a lower module;

FIG. 8 illustrates a configuration of a layout design apparatus in accordance with an embodiment;

FIG. 9 illustrates a flow of a layout process in accordance with an embodiment;

FIG. 10 illustrates contents of a lower module boundary data extraction process in accordance with an embodiment;

FIG. 11 illustrates contents of a lower module data flattening process in accordance with an embodiment;

FIG. 12 illustrates contents of a lower module process in accordance with an embodiment;

FIG. 13 a wiring extraction target near a module boundary frame inside a lower module;

FIG. 14A illustrates a first example where nets with the same name exist in multiple lower modules;

FIG. 14B illustrates a second example where nets with the same name exist in multiple lower modules;

FIG. 15A illustrates an extraction target and extraction results for an upper wiring existing within a fixed region near a lower module;

FIG. 15B illustrates how wiring information for NetB and NetC in FIG. 15A is flattened into a lower module;

FIG. 15C illustrates an example of attribute information indicating that the associated information is upper layer wiring information;

FIG. 16 illustrates a relationship between a wiring connected to a lower module terminal inside a lower module, and an upper layer wiring;

FIG. 17A illustrates an example of an upper layer and a lower layer when conducting hierarchical layout design;

FIG. 17B illustrates an example of a related art, where prohibited wiring regions are provided at the module boundary parts of lower modules;

FIG. 17C illustrates an example of a related art, where the wiring near the module boundaries inside lower modules is extracted, and an upper layer prohibited wiring region is provided; and

FIG. 18 explains problems associated with a related art.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinafter, embodiments for carrying out the invention will be described in detail.

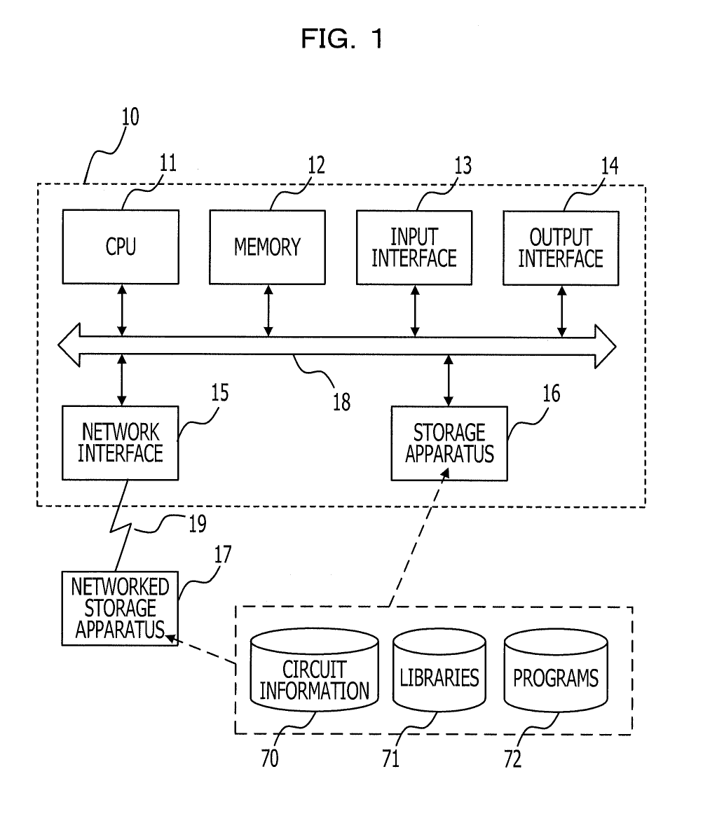

FIG. 1 illustrates an exemplary configuration of a computer 10 for embodying a layout design apparatus, layout design method, and layout verification method in accordance with embodiments disclosed herein. The computer 10 includes a central processing unit (CPU) 11, memory 12, an interface circuit 13 that interfaces with input devices such as a keyboard and mouse, an output interface 14 that interfaces with output devices such as a display, a network interface circuit 15, and a storage apparatus 16. In addition, a networked storage apparatus 17 external to the computer 10 may be connected to the computer 10 via a predetermined network communication line 19. While specific components of the computer 10 and others interfaced therewith are described herein, the present invention is not limited to any particular configuration.

The storage apparatus 16 and the networked storage apparatus 17 may each be any of the following: a magnetic disk apparatus, an optical disc apparatus, a magneto-optical disc apparatus, a semiconductor memory apparatus, or a drive apparatus that handles a computer-readable recording medium. An arbitrary computer-readable recording medium may be used as the recording medium handled by the drive apparatus, such as magnetic tape, a memory card, an optical disc (such as a CD-ROM or DVD-ROM, for example), or a magneto-optical disc (such as an MO or MD, for example).

The storage apparatus 16 and the networked storage apparatus 17 store information such as the following: circuit information 70, which is subjected to layout design; libraries 71 used in layout processes; and programs 72 for conducting layout processes. Via the bus 18 and the respective interface circuits (13, 14 and 15), the CPU 11 accesses components such as the memory 12, the storage apparatus 16 and 17, and various input and output devices. The CPU 11 executes a program 72 stored in the storage apparatus 16 or the networked storage apparatus 17. Alternatively, the CPU 11 may execute a program 72 that has been loaded into the memory 12 or similar storage. The layout processes and other processes in accordance with embodiments hereinafter described are taken to be executed by a CPU 11 included in the computer 10 illustrated in FIG. 1.

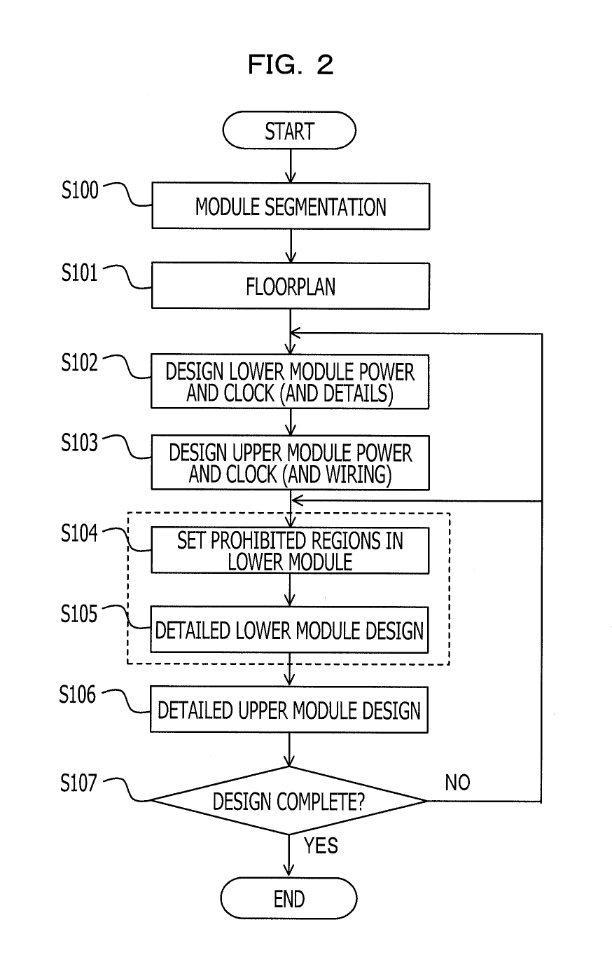

FIG. 2 illustrates one mode of an overall flow of a layout process in accordance with an embodiment. The present invention is not limited to using just the layout process flow in accordance with FIG. 2, and other flows may be applicable thereto. However, for the sake of convenience in the following explanation, embodiments will be hereinafter described using the overall flow in FIG. 2. The prerequisites for conducting the layout process illustrated by the flow in FIG. 2 are assumed to be satisfied in the following explanation. In other words, it is assumed that the circuit to be laid out has logical layers considering hierarchical layout design, and that the logical design has been completed for the circuit to be laid out.

In exemplary overall flow of a layout process illustrated in FIG. 2, the circuit to be laid out is first segmented into modules (S100). In a module segmentation (S100), the layers used in the layout processing (hereinafter referred to as the layout layers) are segmented so as to become circuit blocks of a size suitable for conducting hierarchical layout. Other factors are also taken into account, such as the scale and function of the circuit to be hierarchically laid out, etc. Subsequently, a floorplan allowing for favorable layout processing is created for the segmented modules in the respective layout layers (S101). This floorplan is created while taking into account factors such as the terminal positions, inter-module wiring, the operational frequency, and the circuit scale, for example.

Once a floorplan is created and the module boundary frames for each lower module are determined, the internal power design and clock design is conducted for each individual module (S102). Typically, in the placement and wiring processes conducted after creating a floorplan, features such as the power wiring and clock wiring are given the highest priority, and often the power and clock design is conducted first. In the processing of S102, the processes for designing features such as the power and the clock of each lower module become independent operations for each individual lower module, and thus may be conducted in parallel. Depending on the particular circuitry in a lower module or design progress, the processing in S102 may involve other processes in addition to the power design and clock design of the lower modules. For example, in some cases detailed placement and wiring design may be conducted for some lower modules.

Upon completion of the power and clock design for each lower module, power and clock design is conducted for the upper modules lying in an upper layer that includes the lower modules (S103). At this point, the module terminal positions might already be determined for signal lines other than those of the clocks in the lower modules. In such cases, the wiring and other features with critical timing requirements may be given priority and laid out in advance.

After laying out the power wiring, clock wiring, and wiring for ordinary signals in the upper modules, the layout of each lower module is designed by means of the processing enclosed by broken lines (S104 and S105) in FIG. 2.

In an embodiment, before entering the detailed design phase for each individual lower module, prohibited wiring regions are set in the layout of each lower module (S104). Each prohibited wiring region is set based on information regarding the wiring near the location where a particular lower module is placed. In other words, the prohibited wiring region for each lower module is set based on information regarding the wiring surrounding the lower module or the wiring in the upper layer above the lower module. At this point, if the same lower module is being used at multiple locations, then a prohibited wiring region is set in the layout of that lower module based on information regarding the upper layer wiring at all locations where the lower module is being used. Furthermore, when setting a prohibited wiring region in the layout of a lower module based on upper layer wiring information, the prohibited wiring region may be set to a width equal to the pattern width of the wiring indicated by the upper layer wiring information, plus a predetermined spacing. This predetermined spacing may be, for example, a width that satisfies a predetermining wiring spacing rule. Subsequently, detailed design of the lower modules is conducted while taking into account the prohibited wiring regions set based on upper layer wiring information (S105).

In the detailed design phase for the lower modules in S105, placement and wiring processes are conducted. In addition, layout verifications are conducted, wherein it is determined whether or not the results of the placement and wiring processes satisfy predetermined design rules set with respect to the layout design. In addition, static timing analysis (STA) or similar timing verifications may be conducted. In such timing verifications, the wire resistances and wire capacitances may be extracted from data such as the post-layout wiring information to calculate delays, and the results may be verified to determine whether or not each lower module will operate at a predetermined operational frequency. In addition to STA, the timing verifications may also involve running logical simulations that take into account actual wiring delays, and determining whether or not the circuit will operate at a predetermined operational frequency. If violations are found in the layout verifications or timing verifications, then respective violations may be resolved by returning the process to S102 and revising the placement and wiring as appropriate.

The details of the processing conducted in S104 and S105 are described in detail below. Herein, the detailed wiring for each lower module in S105 may be conducted after setting prohibited wiring regions for all lower modules based on upper layer wiring in S104. Alternatively, the processing in S104 and S105 may be executed in series for each individual lower module. Furthermore, since the detailed layout design for each individual lower module in S105 can be conducted independently, the layout design for multiple modules can also be conducted in parallel in S105.

Once the detailed design is finished for all lower modules included in an upper module, the upper layer layout is designed while taking into account the wiring near the module boundaries inside those respective lower modules (S106). An upper layer layout method that takes into account the wiring near the module boundaries inside the lower modules will be described below in detail.

Once the layout design of the wiring and other processes is finished for the upper module, layout verifications and timing verifications are additionally conducted for the upper module (S106). In the layout verifications, an upper layer layout verification may be conducted by extracting just the wiring inside respective lower modules that might possibly influence the upper layer. Alternatively, the layout data for all lower layers included in the upper layer may be merged into the upper layer layout data. Meanwhile, in the timing verifications, a timing verification may be conducted by merging the layout data for respective lower modules into the upper module layout data. Alternatively, a timing verification of the upper module may be conducted by using a simplified timing model, which is created by extracting information from the layout results of respective lower modules.

If there are violations (i.e., errors) in the layout verifications or timing verifications conducted with respect to the upper module in S106, then the placement and wiring inside the upper module may be revised (S106), or if necessary, the process may be returned to S102 to S105 and the layout of the lower modules may be revised. Subsequently, once any violations requiring revision from the layout verifications and timing verifications in S106 have been resolved, and once the layout design for each lower module has been completed, the layout design is complete (S107 YES).

The detailed design of the upper module can be conducted even in the case where the detailed layout design of some of the lower modules included in the upper module is not yet complete (S106). If the detailed design of all lower modules has not been completed at the point when a first pass of the detailed design of the upper module has been completed, then the design has not been completed according to the parameters checked in S107, and thus the determination result in S107 becomes “NO”. In this case, the process may be returned to S102 or S104, depending on the status of the unprocessed lower modules, and the layout process is continued.

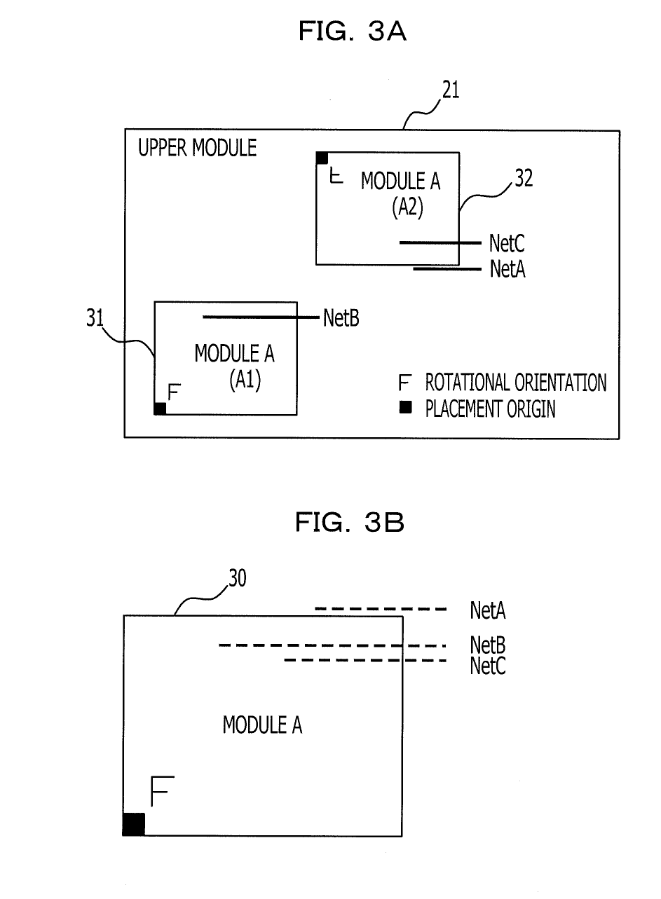

Hereinafter, a processing conducted primarily in S104 and S105 in FIG. 2 is described in detail and with the use of FIGS. 3A and 3B, and the drawings thereafter.

FIGS. 3A and 3B are diagrams for explaining a process of taking information regarding the wiring near the same lower module placed in multiple locations, and flattening that information into a lower module layout database. In other words, FIGS. 3A and 3B are diagrams for explaining a process of adding information regarding the wiring near a lower module. The upper module 21 illustrated in FIG. 3A includes two lower modules 31 and 32, which are two instances A1 and A2 of a module A.

In FIGS. 3A and 3B, the black squares drawn inside the lower modules 30, 31 and 32 are symbols indicating the placement origin when laying out the lower module, while the F symbol is a symbol indicating the rotational direction. The placement origin is a visual indicator of the position of the origin of the coordinate system used when laying out a target module. When a module with an attached F symbol is rotated or reflected, the symbol F is rotated or reflected in the same way, and is thus used to visually indicate the placement orientation of that module. In the layout database, the F symbol may be named the rotation code, for example, and the orientation of the F symbol may be stored in the database by updating a predetermined numerical value or symbol.

In FIG. 3A, the lower module 32 is obtained as a result of vertically reflecting the lower module 31 about the horizontal axis in FIG. 3A, and placing the module in a position different from that of the lower module 31. Herein, wiring NetB is taken to exist in the upper layer near the lower module 31, while wiring NetA and NetC are taken to exist in the upper layer near the lower module 32.

When designing the layout of the lower module A, it is desirable to design the layout while taking into account all of the upper layer wiring NetA, NetB, and NetC that exists near the two placement locations for the lower module A as illustrated in FIG. 3A. In an embodiment, in cases where a lower module A is to be used in multiple locations as illustrated in FIG. 3A, the layout of the lower module A is designed by also setting prohibited wiring regions which are based on the upper layer wiring near all of the placement locations for the lower module.

In FIG. 3A, the lower module 31 and the lower module 32 are vertically reflected with respect to each other, and placed in different positions. For this reason, when flattening the upper layer wiring information into the lower module layout database, it is necessary to convert the upper layer wiring coordinate information to the coordinate systems of the lower modules. In other words, the coordinate information for the upper layer wiring needs to be converted to relative coordinate systems that take into account the placement origin of the lower modules as well as any rotations or reflections. The converted upper layer coordinate information can then be flattened into the lower module layout database.

FIG. 3B illustrates a representation of the case wherein information regarding the respective upper layer wiring that passes near the two lower modules (31 and 32) has been flattened into a database for the layout of the single lower module A (30). As illustrated in FIG. 3B, if the placement origin of the lower module is taken to be at the lower-left of the drawing, then the wiring information for the upper layer NetB is converted to the coordinate system of the lower module A without coordinate conversion, whereas the wiring information for the upper layer NetA and NetC are converted to the coordinate system of the lower module A by vertically reflecting the coordinate information.

In FIG. 3B, the upper layer wiring information (NetA, NetB, and NetC) that has been flattened into the layout database for the lower module A (30) is indicated by broken lines. In order to lay out the lower module A (30) while taking into account the flattened upper layer wiring information, the upper layer wiring information indicated by broken lines is treated as prohibited wiring regions that may not be moved when designing the layout of the lower module A (30). When subsequently verifying the layout of the lower module A (30), the upper layer wiring information indicated by broken lines is treated as pseudo-wiring existing in the layout database for the lower module A (30). In doing so, it becomes possible to design and verify the layout of the lower module A while taking into account the upper layer wiring information. The specific way of handling the upper layer wiring information when designing and verifying the layout of the lower module A will be described in detail below.

Meanwhile, when conducting hierarchical layout, there may be cases where a plurality of lower modules are placed next to each other. In such cases, it may be desirable to place the lower modules adjacent to each other with almost no spacing therebetween, in order to avoid wasting space. In such cases, the internal wiring near the boundary frames of the adjacent lower modules may influence each other.

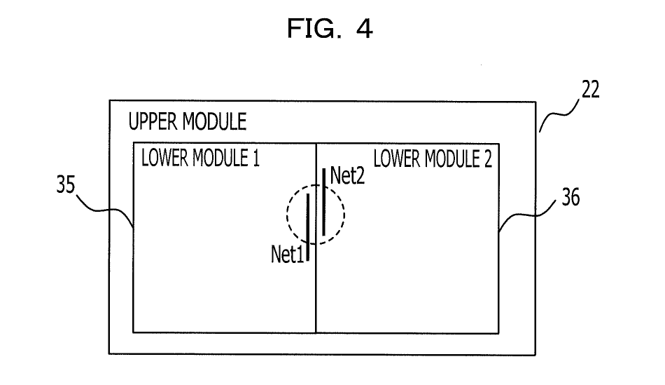

FIG. 4 illustrates an example of the case where the wirings inside adjacent lower modules are influencing each other. In FIG. 4, there exists wiring Net1 near the right edge of the lower module 35 as illustrated in the drawing, and there also exists wiring Net2 near the left edge of the lower module 36 as illustrated in the drawing. In some cases, the respective wiring within the part indicated by the broken circle might influence each other. The influence in this indicated part might produce mutual cross-talk noise, for example, and may trigger a spacing rule violation if the spacing parameters that specify the minimum required wiring spacing are not satisfied.

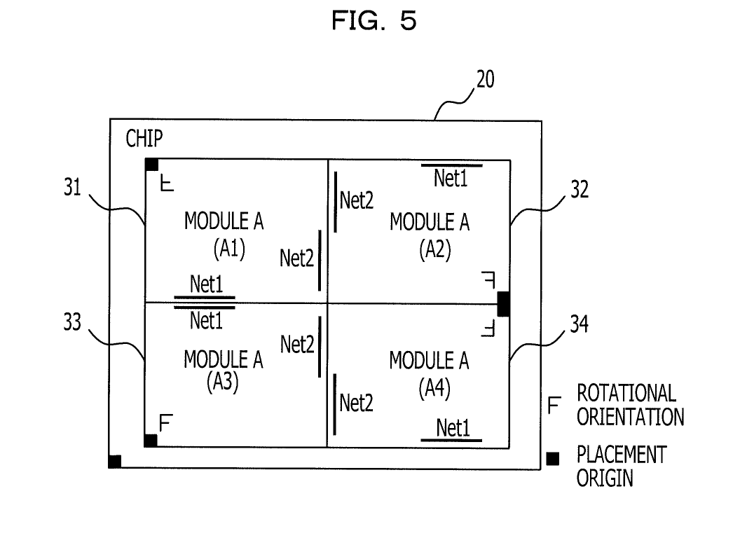

As an example similar to FIG. 4, FIG. 5 illustrates an example of the case where the same lower module A is placed at four adjacent locations in the form of lower modules 31, 32, 33 and 34 on a chip 20. In the case illustrated by way of example in FIG. 5, the internal wiring Net1 and Net2 inside each of the lower modules 31, 32, 33 and 34 may possibly influence the wiring inside their respectively adjacent lower modules.

Given the above, if a layout method is used wherein just the upper layer wiring of the lower modules is focused on and prohibited wiring regions are set when laying out the lower modules (see FIG. 3, etc.), the influence of the wiring inside adjacent modules may cause problems. A similar problem also exists for the technique of the second technology described earlier, wherein the upper layer layout is designed by extracting wiring information near the boundaries of lower modules, and setting prohibited wiring regions based on the extracted wiring information. This is because when designing the layout of a lower module with the second technology described earlier, no particular constraints are applied to take into account the conditions external to that lower module. A similar problem also exists for the third technology described earlier.

Consequently, when laying out a given lower module, it is desirable to take into account not only the upper layer wiring near that lower module, but also the wiring near the module boundaries inside lower modules adjacent to the given lower module.

As a method for satisfying demands described above, an embodiment, information regarding the wiring near the module boundaries inside a lower module is first extracted for each lower module included in an upper module. Subsequently, the extracted information regarding the wiring near the boundaries inside lower modules is provisionally merged into an upper layer layout database. Instead of merging the extracted information regarding the wiring near the boundaries inside lower modules into an upper layer layout database, the information may also be provisionally stored inside the database as special intermediate data.

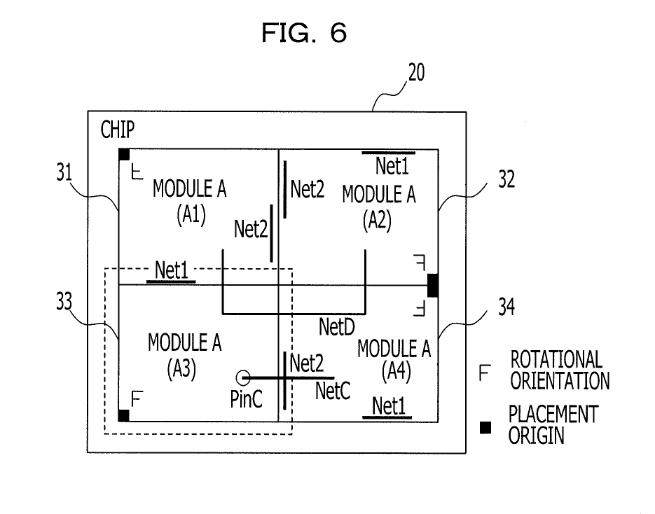

In the example in FIG. 5, the respective wiring information for the wiring Net1 and Net2 in each of the lower modules 31, 32, 33 and 34 is temporarily raised to the upper layer layout database and merged with the upper layer wiring information. Subsequently, the upper layer wiring information that includes the information regarding the wiring near the boundaries inside each lower module is used to extract upper layer wiring information that may possibly influence the lower module being laid out. A prohibited wiring region for laying out the lower module is then set based on the extracted wiring information. In doing so, it becomes possible to design the layout of a lower module while also taking into account the wiring near the boundaries inside adjacent lower modules. Specific examples of the above will now be described with the use of FIGS. 5 and 6.

First, in the layout database for the chip 20 illustrated in FIG. 5, information regarding the wiring near the boundaries inside the lower modules is extracted for each instance (A1, A2, A3 and A4) of the lower modules 31, 32, 33 and 34. Specifically, the following wiring information is extracted: wiring information for Net1 and Net2 inside the lower module 31, wiring information for Net1 and Net2 inside the lower module 32, wiring information for Net1 and Net2 inside the lower module 33, and wiring information for Net1 and Net2 inside the lower module 34. The wiring information extracted at this stage may include other information in addition to information regarding the wiring inside the lower modules. Herein, the extracted information is taken to include information regarding features such as contacts (i.e., vias (vertical interconnect access), etc.) and prohibited wiring regions inside cells, which are configured by certain specific transistors inside a lower module, and which function as particular function blocks. (The above similarly applies to further instances of the term “wiring information” hereinafter.)

Next, the extracted information regarding wiring near the boundaries inside lower modules is merged into the layout database for the upper layer chip 20. At this point, the extracted information regarding wiring inside lower modules carries position information expressed in the individual coordinate systems of respective lower modules, which have been rotated or reflected in various directions. For this reason, the coordinates of the extracted information regarding the wiring inside lower modules is converted to positional coordinates in the coordinate system of the upper layer.

After merging the information regarding the wiring near the boundaries inside the respective lower modules 31, 32, 33 and 34 into the upper layer layout database, upper layer wiring information is extracted for each of the respective lower modules 31, 32, 33 and 34. Such information is information regarding the wiring surrounding a given lower module, or the wiring in an upper layer above that lower module. At this stage, the information regarding the wiring near the boundaries inside adjacent lower modules has been merged into the upper layer layout database, and thus it becomes possible to extract upper layer wiring information that also includes information regarding the wiring inside adjacent lower modules.

In this way, information regarding the upper layer wiring near individual lower modules is extracted by using an upper layer layout database into which information regarding the wiring near the boundaries inside lower modules has been merged. A process for extracting such information will now be described with the use of FIG. 6. Similarly to FIG. 5, FIG. 6 illustrates a status wherein a lower module A has been placed at four adjacent locations, but with the addition of the respective wiring NetC and NetD, which is wiring inside the upper module chip 20.

First, consider the case of extracting information regarding the upper layer wiring near the lower module 33 at the instance A3. The portion enclosed by broken lines in FIG. 6 is herein taken to be either a range of influence on spacing rules or a range of influence on cross-talk noise, as seen from the module frame of the lower module 33. Given the above, the extraction targets become features such as the wiring, contacts, and prohibited wiring regions outside the lower module 33 and inside other modules included in the region enclosed by the broken lines. In FIG. 6, for example, the following features become extraction targets: the wiring Net1 inside the lower module 31, and the wiring Net2 inside the lower module 34, both of which were merged into the upper layer layout database. The respective wiring Net2 inside the lower modules 31 and 32 as well as the respective wiring Net1 inside the lower modules 32 and 34 are not included in the region enclosed by broken lines, and thus are not treated as extraction targets for the upper layer wiring near the lower module 33.

In addition, upper layer wiring in the region enclosed by the broken lines as well as upper layer wiring above the lower module 33 also become extraction targets. In FIG. 6, the wiring NetC and NetD passing over the lower module 33 become extraction targets. Herein, some upper layer wiring above the lower module 33 can be exempted from extraction if that upper layer wiring lies outside both the range of influence on spacing rules as well as the range of influence on cross-talk noise with respect to the wiring inside the lower module 33.

The extraction described above is similarly conducted for the other lower modules 31, 32, and 34 by respectively focusing on a particular lower module, and then extracting information regarding the upper layer wiring surrounding or above that lower module, as well as information regarding the wiring inside adjacent modules.

Unique net names are set with respect to each set of extracted upper layer wiring information. At this point, information related to the wiring information extracted from the lower modules is stored, and includes the module names and instance names of the lower modules from which wiring information was extracted, or information corresponding to the module names or instance names. In doing so, it becomes possible to prevent duplication of data for the same instance when flattening extracted information regarding respective upper layer wiring into the layout database for a single lower module.

Once the extraction of information regarding the wiring near a particular lower module has been completed for all lower modules 31, 32, 33 and 34 in the chip 20, the upper layer wiring information extracted for each instance (A1, A2, A3 and A4) is next flattened into the layout database for a single lower module. At this point, consider an example wherein the layout database for the lower module 33 at the instance A3 is focused on, and the information regarding the upper layer wiring near the placement locations of the lower modules 31, 32, and 34 at the other instances (A1, A2, and A4) is flattened into the layout database for the lower module 33.

The information regarding the upper layer wiring near respective lower modules is extracted with respect to all lower modules, and contains information regarding the wiring Net1 and Net2 inside the lower module 33. Since the information regarding the wiring Net1 and Net2 inside the lower module 33 does not need to be flattened into the lower module 33 itself, this information is removed from the set of target information to be flattened.

In addition, consider cases such as when some kind of error occurs when verifying the layout of the lower modules. In such cases, the designers may want to distinguish between the information regarding wiring inside the lower module, and the information that has been flattened into the lower module layout database as upper layer wiring information. By attaching easily recognizable net names to the upper layer wiring information, it becomes easy for the designers to distinguish between such information. For this reason, it is desirable to control the flattening of upper layer wiring information while also temporarily storing information such as the module names and instance names associated with the wiring information flattened into the lower module layout database.

The unique net names from the upper layer are used for the features to be flattened, such as the wiring, contacts, and prohibited wiring regions. When upper layer wiring information that has been flattened into a lower module layout database is handled as a prohibited wiring region when simply laying out a lower module, information regarding a priority order of the wiring in the upper layer, such as information prioritizing power and clock wiring, is not included. Depending on the wiring priority, in some cases it may be desirable to address the wiring in the upper layer rather than the wiring inside the lower module when an error occurs during layout verification, for example. By attaching the unique net names from the upper layer to the flattened wiring information from the upper layer, it becomes easy for the layout designer to distinguish features.

The wiring and contact information to be flattened is additionally set with attributes enabling such information to be differentiated from ordinary lower module layout data. When information regarding the upper layer wiring near respective lower modules placed in multiple locations is flattened into a single lower module layout database, the wiring information from mutually different locations is combined and flattened into the single lower module layout database. For this reason, overlaps occur in the wiring information that has been flattened into the lower module layout database, and pseudo spacing errors might occur. Consequently, it is necessary to exclude the respective sets of wiring information flattened into the lower module layout database from the layout verifications. When excluding such flattened wiring information from the layout verifications, the attribute information set for the flattened wiring information as described above is used.

Meanwhile, the handling of lower modules may differ in some cases. For example, in some cases a lower module may not only be used as a hard macro, wherein changes to the wiring inside an already laid out lower module are prohibited, but also as a soft macro, wherein changes to the wiring inside the lower module and other modifications are allowed for already laid out lower modules. When using a lower module as a soft macro, a wiring layer identical to the wiring layer using inside the lower module might be used to draw the upper layer wiring. When laying out the lower module wiring in such cases, shorts or other errors between the wiring inside the lower module and the upper layer wiring could occur if the wiring in the upper layer is not accounted for.

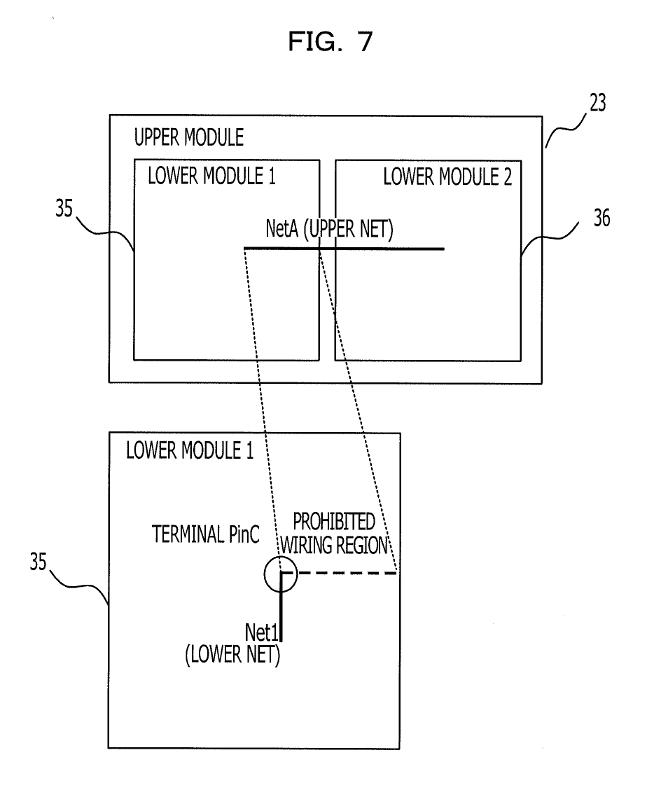

In addition, although in many cases the terminals of a lower module are provided on the outer frame of the lower module, terminals might also be provided on the inside of a lower module, such as the terminal PinC of the lower module 33, illustrated as a circle in FIG. 6. For example, in some cases clock terminals are provided near the center of a lower module in order to ease alignment of clock skew among the respective flip-flops (FFs) at the ends supplied to the clock. In addition, in some cases other specific signal terminals are provided on the inside of a lower module. In such cases, problems will occur with the handling of the upper wiring connected to the lower module terminals when designing the layout of the lower module by taking information regarding the upper layer wiring near lower modules, and flattening that information into the lower module layout database as prohibited wiring regions. Specifically, if the lower module is laid out by setting prohibited wiring regions with respect to the upper layer wiring connected to the lower module terminals, then it will become necessary to execute special processing for connecting the wiring inside the lower module to those terminals. This problem will be described with the use of FIG. 7.

The top part of FIG. 7 illustrates an upper module 23, which includes a lower module 35 and a lower module 36, and wherein wiring NetA is laid out in the upper layer above the lower modules 35 and 36. Herein, the upper layer NetA is taken to be connected to the terminal PinC of the lower module 35 illustrated in the bottom part of FIG. 7. The bottom part of FIG. 7 illustrates how the upper layer NetA has been flattened into the layout database for the lower module 1 as a prohibited wiring region, herein indicated by a broken line. The prohibited wiring region indicated by the broken line in the bottom part of FIG. 7 is connected to the wiring Net1 inside the lower module 35 via the terminal PinC of the lower module 35. Although the terminal PinC is demonstratively illustrated as a circle in the bottom part of FIG. 7, in actuality, such circular wiring or a contact does not even exist, and that in the final layout data, the lower layer Net1 and the upper layer NetA are simply in a connected state.

In the bottom part of FIG. 7, if it is assumed that both the prohibited wiring region indicated by the broken line and the wiring Net1 indicated by the solid line are in the same wiring layer, then the prohibited wiring region and the wiring contact each other at the terminal portion indicated by the circle. Herein, the prohibited wiring region indicated by the broken line is taken to be used for the purpose of securing a fixed spacing between the wiring inside the lower module 35 and the upper layer wiring NetA. Consequently, when the prohibited wiring region is contacting the terminal PinC of the lower module 35, the wiring Net1 inside the lower module 35 may not be connected to the terminal PinC with ordinary layout processing.

Obviously, it is typically possible to forcibly connect Net1 to the terminal PinC contacting the prohibited wiring region in the lower module layout process. Additionally, special processing may also be executed wherein, after laying out the lower module 35 without treating the wiring connection to the terminal inside the prohibited wiring region as an error, a validity of the wiring connection to the terminal inside the prohibited wiring region is determined after combining the layout data of the upper module 35 with the layout data of the upper module 23. However, when the wiring is forcibly connected to the terminal inside the prohibited wiring region in this way, its validity may not be determined at the lower module layout stage, even in cases where the wiring connection is incorrect or where the wiring connection fails to satisfy design rules for the layout. In other words, any failures to satisfy design rules are only first ascertained when verifying the layout of the entire upper module 23. For this reason, when a problem occurs the resulting layout after executing such special processing, there is increased processing time between revising the layout and confirming the validity of the revision results, and work efficiency suffers as a result.

Consequently, when given wiring such as the upper layer NetA that is to be connected to the terminal PinC in the lower module 35 being laid out, it is not desirable to treat the wiring NetA as a simple prohibited wiring region. Instead, it is desirable to recognize NetA to be wiring inside the lower module 35 when verifying the layout of the lower module 35. For this reason, in an embodiment of the present invention, an upper layer wiring is treated as a prohibited wiring region when laying out a lower module, but at the same time, the upper layer wiring is treated as wiring inside the lower module when verifying the layout of the lower module. In doing so, the above problem is resolved.

A specific processing method involves the following. Among the upper layer wiring information that is flattened into a lower module, there may exist information regarding wiring to be connected to a terminal in the lower module. For such information, the lower module terminal name is appended to the upper layer net name. By appending the lower module terminal name to the upper layer net name, it becomes possible to determine whether or not flattened upper layer wiring is to be connected to a lower module terminal when designing the layout of the lower module. For example, upper layer wiring to be connected to a lower module terminal may be flattened into the lower module layout database with a name given by net_name+delimiter+terminal_name. Thus, if the upper layer wiring NetA is to be connected to a terminal PinC, then NetA is flattened into the lower module layout database with the name “NetA.PinC”. In this example, the delimiter is a period (“.”). By applying such a net name, it can be determined whether or not the last part of the delimited net name includes a terminal name when designing the layout using a lower module layout database. In doing so, it becomes possible to determine whether or not the corresponding upper layer wiring is to be connected to a terminal.

Among the upper layer wiring information that is flattened into a lower module, there may exist information regarding wiring not to be connected to a terminal in the lower module. Such information may be flattened into the lower module layout database using the unmodified upper layer net name, for example.

As described earlier, the information regarding the upper layer wiring that is flattened into a lower module layout database is for the purpose of laying out a lower module while taking into account the upper layer wiring. Consequently, when designing the layout of a lower module, the flattened upper layer wiring information is treated as prohibited wiring information. In addition, when verifying the layout, it is determined whether or not certain layout design rules are satisfied between the upper layer wiring that has been flattened into the lower module layout database, and the wiring inside the lower module being laid out. In other words, verifications are made to determine factors such as whether or not design or other rules are satisfied, whether or not shorts exists, and whether or not the problem of cross-talk noise will occur between the upper layer wiring that has been flattened into the lower module layout database, and the wiring inside the lower module being laid out. When verifying the layout of a lower module, layout checks between flattened upper layer wiring is not conducted.

The handling of upper layer wiring information that is flattened into a lower module layout database will now be specifically described. When laying out a lower module, information regarding the upper layer wiring to be connected to the terminal PinC is treated as an immoveable, prohibited wiring region. Then, when verifying the layout, the upper layer wiring information is recognized to be wiring connected to Net1 inside the lower module via PinC. During the layout verification, and particularly during short checks, net names as described earlier are used, wherein the lower module terminal name is appended to the net name of the flattened upper layer wiring. Such net names are used to detect shorts at the terminal by determining whether or not particular wiring is allowed to contact that terminal.

Among the upper layer wiring information that is flattened into a lower module layout database, there may exist upper layer wiring not to be connected to a terminal in the lower module. Such wiring is simply treated as prohibited wiring regions when laying out the lower module, and is recognized to be wiring existing inside the lower module when verifying the layout.

By processing the information regarding upper layer wiring to be connected to a terminal in a lower module in this way, it becomes possible to detect shorts with upper wiring at terminals and other problems that could not be detected when verifying a lower module using the technology of the related art. Furthermore, at the lower module layout verification stage, it becomes possible to evaluate the layout in a form that includes the upper layer wiring. When the same lower module is being used at multiple locations, layout design and layout verification of the lower module are conducted while taking into account the upper layer wiring conditions near the lower module at the multiple locations. Moreover, layout can be conducted while taking into account the wiring inside lower modules adjacent to the lower module being laid out, as described earlier. For this reason, it becomes possible to discover and address problems between the wiring inside lower modules in advance, even problems that could only be discovered during the upper layer layout verification when using the technology of the related art.

Consequently, when designing the layout of a lower module, the layout can be verified with a single check that even checks for cross-talk noise and other influences between the wiring in the module being laid out and the upper layer wiring or the wiring inside adjacent modules at the multiple locations where the lower module is to be used. In doing so, it becomes possible to address errors and other issues in advance. Additionally, since errors can be discovered and addressed in advance before conducting a comprehensive layout verification that includes both the lower modules and the upper module, it becomes possible to shorten the overall layout processing time.

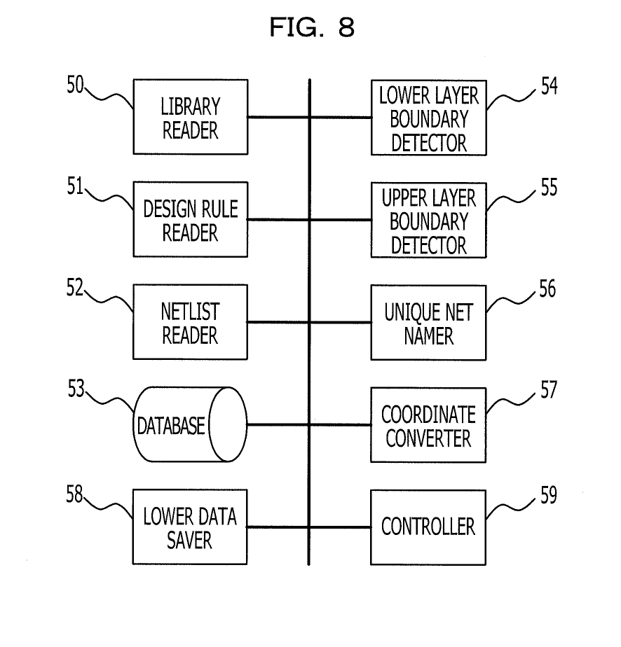

The configuration and layout processing of a layout design apparatus in accordance with an embodiment will be hereinafter described in detail with the use of FIGS. 8 to 16.

FIG. 8 illustrates the configuration of a layout design apparatus in accordance with an embodiment. The layout design apparatus in accordance with an embodiment herein includes a library reader 50, a design rule reader 51, a netlist reader 52, a database 53, a lower layer boundary detector 54, an upper layer boundary detector 55, a unique net namer 56, a coordinate converter 57, a lower data saver 58, and a controller 59.

The library reader 50 in FIG. 8 reads out libraries for cells constituting a circuit whose layout is to be designed. The libraries are read out from, for example, library information 71 stored in an apparatus such as the storage apparatus 16 illustrated in FIG. 1. The library reader 50 reads out information such as terminal information, wiring information, contact information, prohibited wiring region information, and driving performance information for each cell. Herein, a cell refers to a function block made up of specific transistors, with the cell realizing a logic circuit such as an AND, OR, or a sequential logic gate such as an FF, for example. In the case where the circuit to be laid out includes hard macros that present some particular function components such as random access memory (RAM) other than the cell, the library reader 50 also reads out relevant hard macro library information.

The design rule reader 51 in FIG. 8 performs processing such as reading out design rules, which are rules specifying how wiring patterns are to be laid out. The design rules are read out from library information 71 stored in an apparatus such as the storage apparatus 16 illustrated in FIG. 1. Examples of design rules include: spacing rules, which specify parameters such as the minimum wiring spacing according to the fabrication process and pattern width; and parallel wiring length rules.

The netlist reader 52 in FIG. 8 reads out netlists, which express circuit information in accordance with predetermined rule(s). The netlists are read out from circuit information 70 stored in an apparatus such as the storage apparatus 16 illustrated in FIG. 1. The database 53 is a database that includes the circuit information 70 and the library information 71 illustrated in FIG. 1 that are needed for layout design, as well as various types of layout data generated during layout design. The data contained in the database 53 in FIG. 8 is stored in an apparatus such as the memory 12, the storage apparatus 16, or the networked storage apparatus 17 illustrated in FIG. 1.

The lower layer boundary detector 54 in FIG. 8 detects and recognizes wiring existing near the module boundaries inside lower modules. The upper layer boundary detector 55 detects and recognizes upper layer wiring existing near the module boundaries of lower modules. The unique net namer 56 generates unique net name information with respect to the wiring detected by the lower layer boundary detector 54 and the upper layer boundary detector 55.

In the case of processing wiring or other information in a lower layer together with upper layer information, or in the case of processing wiring or other information in an upper layer together with lower layer information, the coordinate converter 57 in FIG. 8 conducts processing to match the coordinate systems in the respective wiring or other information. The lower data saver 58 saves intermediate data for layout processing in the database 53. The intermediate data may be, for example, information regarding wiring inside lower modules near the lower module boundaries, which has been detected by the lower layer boundary detector 54 and converted into the upper layer coordinate system by the coordinate converter 57. The controller 59 controls the operation of the various components (50, 51, 52, 53, 54, 55, 56, 57 and 58) constituting the layout design apparatus, and executes processing for laying out a semiconductor integrated circuit.

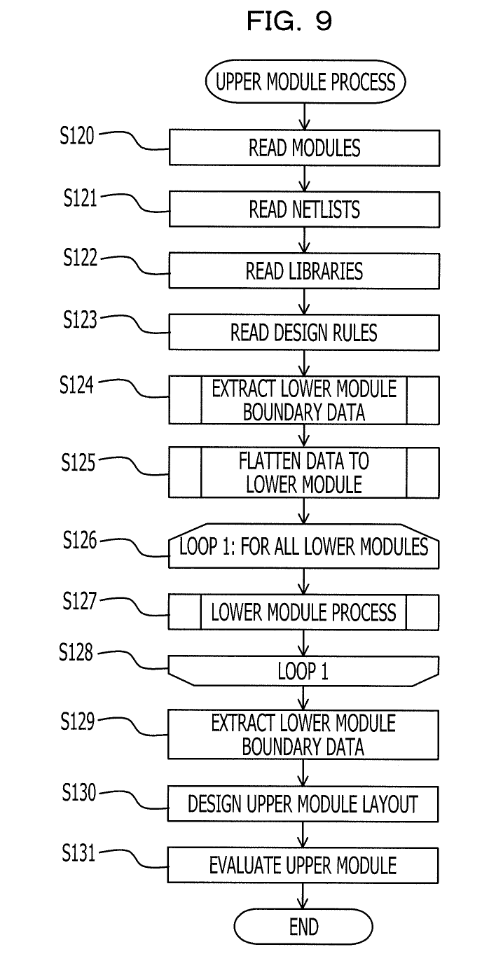

FIG. 9 summarizes a flow of the layout processing for setting lower module prohibited wiring regions and thereafter (i.e., S104, S105 and S106 in FIG. 2) as part of the layout processing in accordance with an embodiment.

First, as a result of the module reading process in S120, a layout database for the upper module to be laid out is read out from the database 53 stored in the storage apparatus 16 or similar apparatus, and information such as the wiring information, contact information, and cell and module placement information for the upper module is read out. In addition, in the module reading process in S120, information required for layout design is also read out, such as placement information for cells included in the respective lower modules contained in the upper module.

Next, netlists for the upper module and each lower modules are read out (S121), cell libraries are read out (S122), and design rules are read out (S123). The individual processes in S121, S122 to S123 are conducted by the library reader 50, the design rule reader 51, and the netlist reader 52 in FIG. 8, respectively.

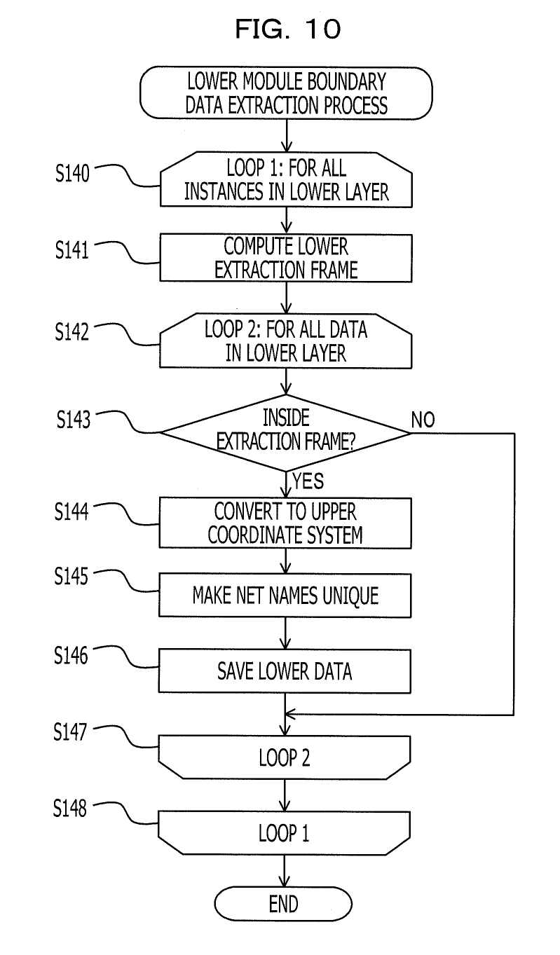

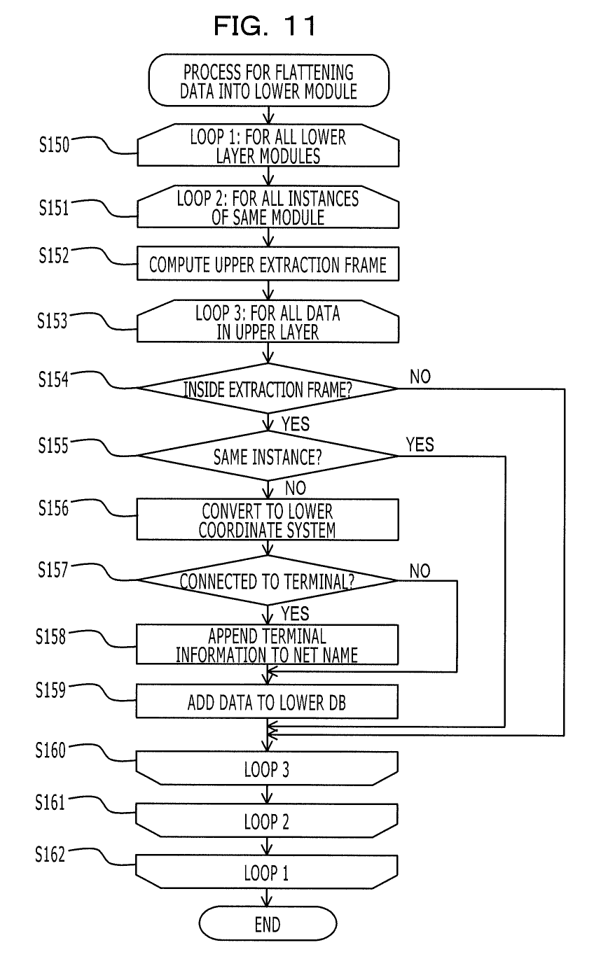

After reading out the information required for layout design in S120, S121, S122 to S123 of FIG. 9, information regarding the wiring near the boundaries inside lower modules is extracted (S124). Subsequently, the information regarding the wiring near the boundaries inside lower modules that was extracted in S124 is combined with upper layer wiring information and flattened into a lower module layout database as constraint information for use when designing the layout of a lower module (S125). At this point, if the same lower module is being used at multiple locations, then processing is conducted to merge the upper layer wiring or other information at the multiple locations where each lower module is placed, and generate prohibited wiring regions or similar constraint information for use in designing the layout of the lower module. The respective processing blocks in S124 and S125 are described in detail below with the use of FIGS. 10 and 11.

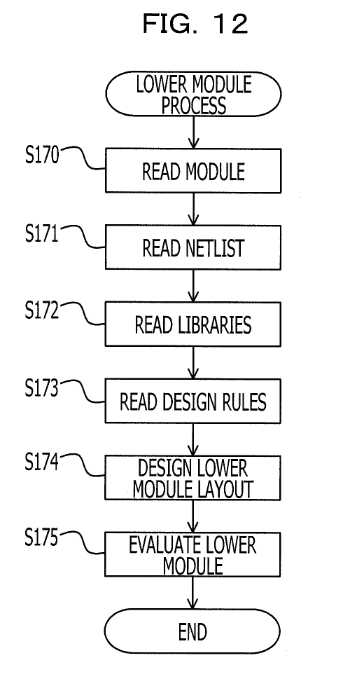

After flattening the layout constraint information into the lower module (S125), the detailed lower module layout is designed (S127) for all lower modules by iterating a processing loop 1 enclosed by S126 and S128. The processing block S127 for designing the detailed lower module layout is described in detail below with the use of FIG. 12.

Once the designing of the detailed layout for all lower modules is completed, information regarding the wiring near the module boundaries inside respective lower modules is once again extracted (S129), and the layout of the upper module is designed while taking into account the extracted wiring information (S130). Subsequently, an upper module evaluation (S131) is conducted, which involves performing upper module layout verifications and timing verifications. If some kind of error occurs in the upper module evaluation in S131, then suitable revision processing is conducted according to the error content, and both the upper module evaluation (S131) and revision are repeated until the error disappears. Then, if no further errors occur in the respective verifications, the series of processes in FIG. 9 is terminated.

FIG. 10 is a diagram for explaining the details of the lower module boundary data extraction process of S124 in FIG. 9. In the respective processes (S140, S141, S142, S143, S144, S145, S146, S147 to S148) in FIG. 10, information regarding wiring near the module boundaries inside lower modules is extracted and otherwise processed. Hereinafter, the content of these respective processes will be specifically described.

First, with the processing loop (loop 1) enclosed by S140 and S148, the processing from S141, S142, S143, S144, S145, S146 to S147 is repeated in order for all lower modules.

In an embodiment, when extracting information regarding wiring near the module boundaries inside lower modules, an extraction frame is set inside the lower module and separated from the outer frame of the lower module by a predetermined spacing (this extraction frame is hereinafter referred to as the lower extraction frame). Information is then extracted regarding wiring existing within the region between the lower extraction frame and the outer module frame. The wiring information referred to at this point is taken to include physical information, such as the wiring, contacts, cell terminals, and prohibited wiring regions inside cells that exist within the region between the lower extraction frame and the outer module frame. In addition, the wiring information referred to at this point is also taken to include the net names of the wiring and other elements. (The above applies to further references to wiring information hereinafter).

Wiring near the boundaries inside lower modules is extracted in order to extract in advance wiring that might cause problems such as design rule violations with respect to the upper layer wiring near the target lower module, or with respect to the wiring inside other lower modules adjacent to the target lower module. In other words, wiring that might cause problems such as design rule violations is extracted in advance when designing the layout, and such wiring is then taken into account when attempting to design the layout of the target lower module or the upper module.

In S141, a lower extraction frame is set for each lower module wiring layer, with each frame being separated from the outer frame of the lower module by a predetermined spacing. Herein, a value used for the spacing between the outer frame of the lower module and the lower extraction frame may be the maximum spacing value for the maximum spacing parameter among the spacing parameters set according to the various pattern widths of the wiring included in each wiring layer inside the lower module. For convenience, the maximum spacing value used to compute the lower extraction frame inside the lower module will be referred to as the maximum lower layer spacing. The maximum spacing value may be computed by the processing of S141 in FIG. 10, or at an earlier stage of the process, such as when reading out the design rules (S123) in FIG. 9.

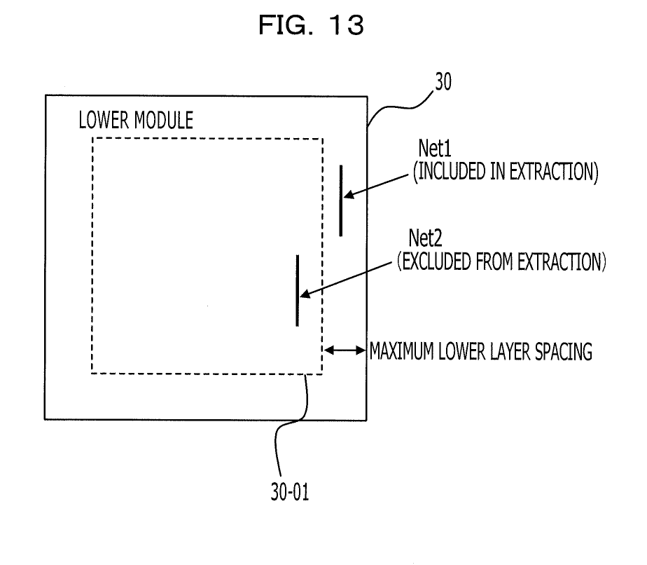

The setting of the lower extraction frame in S141 will now be described with the use of FIG. 13. In FIG. 13, a lower extraction frame 30-01 is drawn with broken lines, and is separated from the outer frame of the lower module 30 by a spacing equal to the maximum lower layer spacing. The region enclosed by the lower extraction frame 30-01 and the outer frame of the lower module 30 (i.e., the frame drawn with solid lines and enclosing the lower module 30) is the region near the boundaries inside the lower module 30 targeted in an embodiment.

As illustrated in FIG. 13, two wiring patterns (Net1 and Net2) are assumed to exist inside the lower module. Net1 is contained in the region enclosed by the lower extraction frame and the outer frame of the lower module 30. Consequently, Net1 is wiring that becomes targeted for extraction as wiring near the boundaries inside the lower module 30. Since Net2 exists inside the lower module 30 further inward than the lower extraction frame 30-01, Net2 does not become targeted for extraction as wiring near the boundaries inside the lower module 30.

In FIG. 13, the maximum lower layer spacing value is used to set the lower extraction frame. However, another value may be used to set the lower extraction frame, such as the inter-wire distance at which cross-talk is produced between parallel wires of given length. In this case, a comparison is made between the inter-wire distance at which cross-talk is produced and the maximum lower layer spacing value, and the larger value is chosen instead of the maximum lower layer spacing value. This larger value may then be used to set the lower extraction frame inside the lower module, and the lower extraction frame is separated from the outer frame of the lower module by a spacing equal to this larger value.

Once the process to set the lower extraction frame in S141 of FIG. 10 is completed, information regarding the wiring contained in the region enclosed by the lower extraction frame and the outer frame of the lower module is extracted for all wiring layers inside the lower module. Specifically, in the processing loop (loop 2) enclosed by S142 and S147 in FIG. 10, a determination is made against all the information for all wiring inside the lower module, and for each wiring layer of the lower module. The determination checks whether or not particular wiring is contained in the region enclosed by the lower extraction frame and the outer frame of the lower module, and wiring information contained in the region is then extracted.

In the parameter determining block of S143 in FIG. 10, it is determined whether or not particular wiring data is contained in the region enclosed by the lower extraction frame and the outer frame of the lower module. The determination of S143 is made for each set of wiring data inside the lower module. If the wiring data is contained in the region (S143 YES), then the process proceeds to S144 with the wiring data treated as extracted wiring information. In contrast, if the wiring data is not contained in the region (S143 NO), then the process proceeds to S147 and S142, and the parameter determination is made for the next set of wiring data (S143). The process of S143 is conducted by the lower layer boundary detector 54 in FIG. 8.

The wiring information extracted in S143 of FIG. 10 is typically expressed in a coordinate system of the lower module. Thus, in order to process such information together with upper layer wiring data in a later process, the extracted wiring information is converted to the coordinate system of the upper layer (S144).

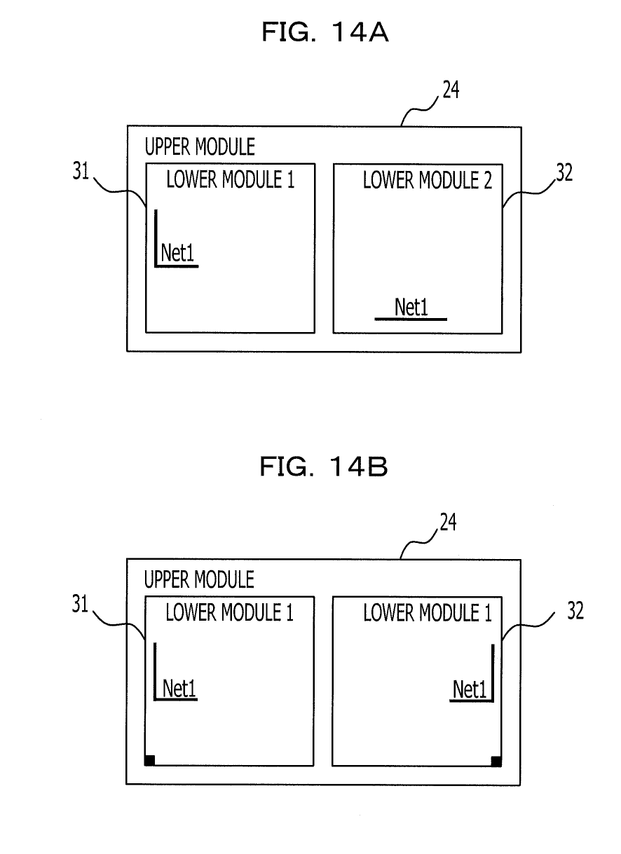

In addition, in some cases, the same net name might be used inside multiple, different lower modules as illustrated in FIG. 14A (see FIG. 14A, 31 and 32). In other cases, the same lower module might be used at multiple locations, as illustrated in FIG. 14B (see FIG. 14B, 31 and 32). In this way, when a lower module is being used at multiple locations or when the same net name from another module is being used, the net names associated with the extracted wiring information are made unique in order to uniquely specify the extracted wiring information (S145). The method for making the net names unique may involve, for example, appending the upper layer instance name of a lower module to the net names inside that lower module. In doing so, the extracted wiring information is made unique. The process for making the net names unique is conducted by the unique net namer 56 in FIG. 8.

After converting the extracted wiring information to the upper coordinate system (S144) and making the net names unique (S145), the extracted lower data is temporarily saved to the database 53 in FIG. 8 in order to enable the use of information related to the extracted lower data in a later process. The process for saving the lower data is conducted by the lower data saver 58 in FIG. 8.

Once the process for extracting information regarding the wiring near the module boundaries inside a given lower module (S140, S141, S142, S143, S144, S145, S146, S147 to S148 in FIG. 10) is finished for all lower modules, information regarding the wiring surrounding a given lower module or the upper layer wiring above a given module is extracted for each type of lower module. If the same type of lower module is being used at multiple locations, then information regarding the upper layer wiring near the lower module is extracted for all locations. At this point, the wiring information that was extracted from inside lower modules and saved in S146 of FIG. 10 is also treated as being wiring information existing in the upper layer. In doing so, it becomes possible to additionally extract information regarding wiring near the module boundaries inside adjacent lower modules in cases where other lower modules exist adjacent to the current lower module.

Subsequently, the extracted upper layer wiring information is flattened into a lower module layout database as lower module layout constraint information. By flattening the wiring information surrounding all placement locations of the current lower module into the lower module layout database, it becomes possible to lay out the lower module while taking into account the wiring conditions surrounding that lower module at its multiple locations. The process for flattening data into a lower module will be described with the use of FIG. 11. In the following description using FIG. 11, it is assumed that the wiring information extracted from inside lower modules and saved in S146 of FIG. 10 is contained in the upper layer wiring information.

FIG. 11 illustrates contents of a process for flattening upper layer wiring data into a lower module. In the process illustrated in FIG. 11, first each type of lower module placed in the upper layer is selected in order by means of the processing loop (loop 1) enclosed by S150 and S162. Then, the processing loop (loop 2) enclosed by S151 and S161 targets, in order, each specific instance where the lower module selected in S150 is used. For each instance targeted in S151, a predetermined extraction frame is computed to demarcate a surrounding region on the outside of that lower module (S152).

In the computation of the upper extraction frame in S152, an extraction frame is set outside the current lower module and separated from the outer frame of the lower module by a predetermined spacing (this extraction frame is hereinafter referred to as the upper extraction frame). Herein, the value used for the spacing between the outer frame of the lower module and the upper extraction frame may be the maximum spacing value for the maximum spacing parameter among the spacing parameters set according to the various pattern widths of the wiring included in each wiring layer of the upper module. For convenience, the maximum spacing value used to compute the upper extraction frame inside the lower module will be referred to as the maximum upper layer spacing. The maximum spacing value in accordance with the maximum upper layer spacing may be computed by the processing of S152 in FIG. 11, or at an earlier stage of the process, such as when reading out the design rules (S123) in FIG. 9.

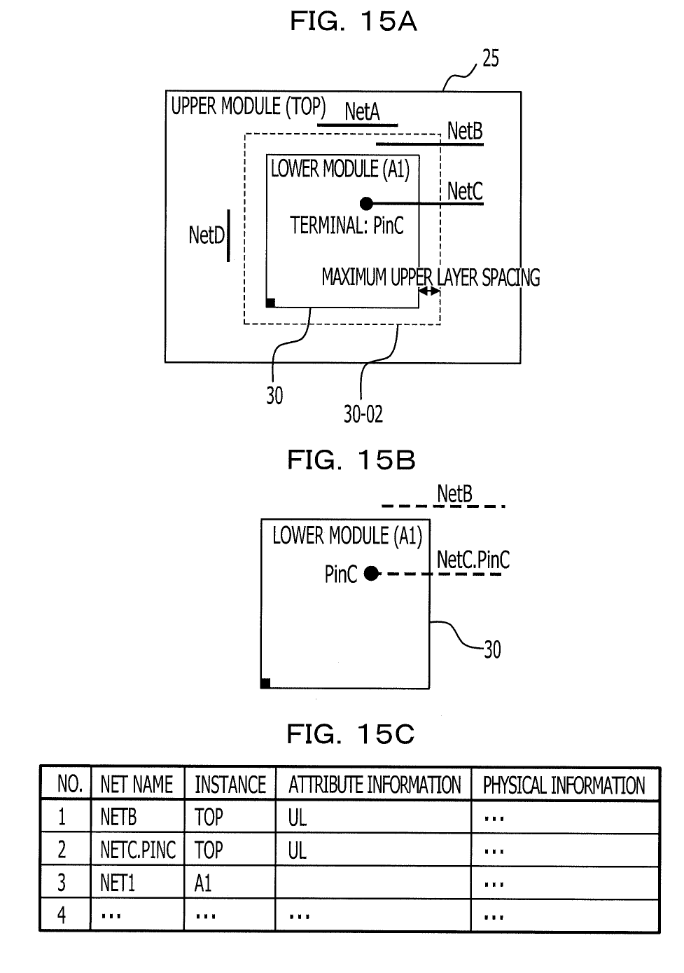

The setting of the upper extraction frame in S152 of FIG. 11 will now be described with the use of FIG. 15A. In FIG. 15A, an upper extraction frame 30-02 is drawn with broken lines, and is separated from the outer frame of the lower module 30 by a spacing equal to the maximum upper layer spacing. Upper layer wiring information contained within a region enclosed by the upper extraction frame 30-02 and including the lower module 30 is wiring information that becomes targeted for extraction as information regarding upper layer wiring near the lower module 30.

As illustrated in FIG. 15A, four wiring patterns (NetA, NetB, NetC, and NetD) are assumed to exist inside the upper module 25. It can be seen from FIG. 15A that NetB and NetC are wiring patterns that are contained within or passing through the region enclosed by the upper extraction frame 30-02. Consequently, in FIG. 15A, NetB and NetC are wiring patterns that become targeted for extraction as information regarding upper layer wiring near the lower module 30. In FIG. 15A, NetA and NetD only pass on the outside of the upper extraction frame 30-02, and thus the wiring patterns of NetA and NetD do not become targeted for extraction as information regarding upper layer wiring near the lower module 30.

When extracting information regarding upper layer wiring near the lower module 30, if the extracted upper layer wiring information is information that has been extracted from inside the current lower module, and is also wiring information related to the lower module at the current instance, then that wiring information is excluded from extraction.

Returning now to FIG. 11, the process for extracting information regarding upper layer wiring near respective lower modules and processes thereafter will now be described. Once the process for computing the upper extraction frame in S152 of FIG. 11 is finished, the processing loop (loop 3) enclosed by S153 and S160 determines whether or not the data for all upper layer wiring information is contained in the upper extraction frame set in S152 (S154). Specifically, a determination is made against the upper layer wiring information, as well as the wiring information that was extracted from inside lower modules and saved in S146 of FIG. 10. If the upper layer data selected in S153 is not contained in the upper extraction frame (S154 NO), then the process again returns to S153 via S160, and it is determined whether or not the next set of upper layer data is contained in the upper layer extraction frame (S154). If the upper layer data selected in S153 is contained in the upper extraction frame (S154 YES), then the process proceeds to S155. These processes related to FIG. 11 are conducted by the upper layer boundary detector 55 in FIG. 8.

In S155, it is determined whether or not the upper layer data selected in S153 is data that was extracted from inside the lower module at the current instance selected in S151. In other words, in S155, it is determined whether or not the upper layer data selected in S153 is data that was extracted from the lower module at the current instance selected in S151. If the upper layer data selected in S153 is data that was extracted from the same instance of the module (S155 YES), no processing occurs, the process returns again to S153 via S160, and the next set of upper layer data is processed. If the upper layer data selected in S153 differs from the data that was extracted from the same instance of the module (S155 NO), then the process proceeds to S156.

Meanwhile, the upper layer data selected in S153 includes coordinate information in the coordinate system of the upper layer, and may not be used as-is in the lower module. For this reason, in S156, the upper layer data selected in S153 is converted to the lower layer coordinate system for the lower module selected in S150. In other words, the coordinate information for the upper layer data selected in S153 is converted to the coordinate system of the lower module selected in S150 by referencing upper layer placement coordinates and rotation codes. Such processing related to S156 is conducted by the coordinate converter 57 in FIG. 8.

Next, in S157 of FIG. 11, it is determined whether or not the upper layer data whose coordinates were converted in S156 is wiring connected to a terminal of the lower module associated with the current instance selected in S151. At this point, if upper layer data subject to the determination in S157 is wiring connected to a terminal of the lower module (S157 YES), then in S158, the lower module terminal name is appended to the net name of that wiring. The process in S158 is done in order to recognize the wiring as being wiring connected to a terminal in later processing, such as when verifying the layout of the lower module.

The contents of the processing in S158 will now be described with the use of FIGS. 15A to 15C. As described earlier, in the example illustrated in FIG. 15A, the wiring patterns NetB and NetC become targeted for flattening into the lower module. FIG. 15B illustrates how the wiring information for NetB and NetC in FIG. 15A is flattened into a lower module. In FIG. 15B, upper layer wiring that has been flattened into the lower module (i.e., NetB and NetC) is illustrated with broken lines.

In FIGS. 15A and 15B herein, NetC is connected to a terminal PinC in the lower module. In such cases, the lower module terminal name PinC is appended to the wiring pattern name NetC, and the wiring pattern NetC that is flattened into the lower module is given the wiring pattern name “NetC.PinC”, as illustrated in FIG. 15B (S158 in FIG. 11). By applying such a wiring pattern name, it can be determined whether or not the last part of the net name contains a terminal name when designing the layout of the lower module. In doing so, it becomes possible to determine whether or not wiring information flattened from the upper layer is upper layer wiring connected to a terminal.

In an embodiment, the terminal name is appended to the net name when flattening information regarding upper layer wiring connected to a lower module terminal into a lower module. However, other means may be used to determine whether or not particular wiring is upper layer wiring connected to the terminal of a lower module. For example, it is also possible to adopt a method wherein list data of the net names of upper layer wiring connected to a lower module terminal is separately created. Such list data may then be referenced during a subsequent lower module layout process and read as the net names.

In S158 of FIG. 11, if the upper layer data is information regarding upper layer wiring connected to a lower module terminal (S157 YES), then the lower module terminal name is appended to the net name of that wiring, and information is added to the lower module layout database (S159). If the upper layer data is information regarding upper layer wiring that is not connected to a lower module terminal (S157 NO), then the process proceeds directly to S159 while skipping S158, and information is added to the lower module layout database.

In S159 of FIG. 11, the information extracted in S154, S155, S156, S157 to S158 (i.e., information regarding upper layer wiring near lower modules) is flattened into the lower module layout database. In other words, the information is added (merged) to the lower module layout database. At this point, the upper layer wiring information is not flattened as simple prohibited wiring information. Instead, attribute information is set with respect to the information regarding upper layer wiring near lower modules. Such attribute information enables the flattened information to be distinguished from information regarding the wiring inside the lower module, and is set in order to identify the wiring information that has been flattened from the upper layer.

An example of attribute information indicating upper layer wiring information is illustrated in FIG. 15C. FIG. 15C illustrates an example of wiring information stored in the layout database for the lower module illustrated in FIGS. 15A and 15B. The data illustrated in FIG. 15C for the wiring information stored in the layout database includes information for fields such as serial number (No.), net name, instance name, attribute information, and physical information. In FIG. 15C, the wiring information associated with the net names “NetB” and “NetC.PinC” is the same as the wiring information illustrated in FIGS. 15A and 15B, while the wiring information associated with the net name “Net1” is information regarding the wiring inside the lower module 30. All other wiring information is herein omitted. In addition, in FIG. 15C, physical information such as the pattern widths and position information with respect to particular wiring information is also herein omitted.

As illustrated in FIG. 15C, attribute information can be set by adding unique information such as “UL” to the attribute information fields of the upper layer wiring information associated with the net names “NetB” and “NetC.PinC”, for example. Attribute information indicating the upper layer wiring information may also be set and saved in different ways.

When laying out a lower module, a check is made to determine whether or not attribute information has been set with respect to wiring or other features. If attribute information indicating upper layer wiring information has been set, then that wiring information is treated as a prohibited wiring region. Then, when verifying the layout of the lower module, verifications are not conducted between wiring to which such attribute information has been added.

For example, if a lower module is being used at multiple locations as in FIG. 6, then in loop 2 of S151 in FIG. 11, information regarding upper layer wiring near that lower module is extracted in order for all instances of that lower module. Subsequently, via the respective processes in S153, S154, S155, S156, S157, S158 to S159, the information regarding upper layer wiring near all locations of the lower module is flattened into a single lower module layout database. By flattening information regarding upper layer wiring near multiple locations of a lower module into the lower module layout database in this way, it becomes possible to lay out the lower module while taking into account the wiring conditions near the lower module at multiple locations.

After conducting the flattening process illustrated in FIG. 11 for all lower modules (i.e., after conducting the processing of S125 in FIG. 9), the detailed layout of the lower module is designed while taking into account the upper layer wiring information that was flattened in S125. In the flow illustrated in FIG. 9, the processing of loop 1 enclosed by S126 and S128 causes the detailed lower module layout design in S127 to be conducted for all lower modules.

In the lower module layout process of S127, lower module placement and design of features such as wiring are conducted while also taking into account the information regarding upper layer wiring near the lower module. In addition, lower module layout verifications and timing verifications are also conducted. The process for designing the detailed layout of a lower module in S127 may be conducted independently of the upper layout design, and may also be conducted independently and in parallel with processes for other lower modules. The contents of the process for laying out a lower module in S127 will now be described with the use of FIG. 12.

FIG. 12 illustrates the contents of a lower module process in accordance with an embodiment. In the lower module process flow, first the layout database and the netlist are read out for the lower module to be laid out (S170 and S171). Subsequently, libraries and design rules required by the lower module layout process are read out (S172 and S173). Herein, if the respective data required by the lower module layout process has already been read out in an earlier process (such as in S120, S121, S122 to S123 in FIG. 9, for example), then the processing in S170, S171, S172 to S173 in FIG. 12 may be omitted.

In the lower module design of S174 in FIG. 12, lower module design such as placement and wiring are conducted while also taking into account the information regarding upper layer wiring near the lower module that was flattened into the lower module layout database as a result of the respective processes in FIG. 11. Specifically, lower module design such as placement and wiring is conducted while treating upper layer wiring near the lower module as immoveable, prohibited wiring regions. At this point, wiring inside the lower module that is connected to a terminal in the lower module is led to that terminal, even if that terminal overlaps with a prohibited wiring region set based on the upper layer wiring information. This is done because any layout verification errors that may occur as a result of overlaps between wiring inside the lower module and prohibited wiring regions at such terminal portions can be treated as non-errors by means of a method is described in detail below.

Once the lower module placement and design of features such as wiring in S174 is finished, layout verifications and timing verifications are conducted in the lower module evaluation of S175. Herein, if processes such as lower module placement and wiring have already been conducted at an earlier stage (such as in S102 of FIG. 2, for example), then it is possible to omit the designing in S174 of FIG. 12, and perform only the layout verifications and timing verifications.

In the layout verification in S175, the wiring and other features inside the lower module are verified to determine whether or not predetermined design rules such as spacing parameters have been satisfied, or whether or not particular features are being influenced by problems such as cross-talk noise.

Design rule checks, cross-talk noise verifications, and similar verifications with respect to wiring and other features inside the lower module are also conducted for the wiring information that was flattened from the upper layer. At this point, layout verifications are conducted by treating the wiring information flattened from the upper layer as wiring existing inside the lower module, or as prohibited wiring regions.

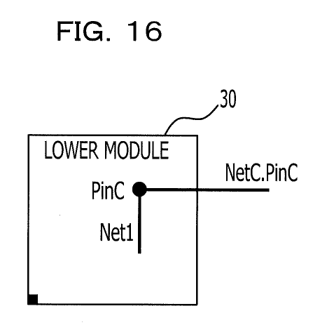

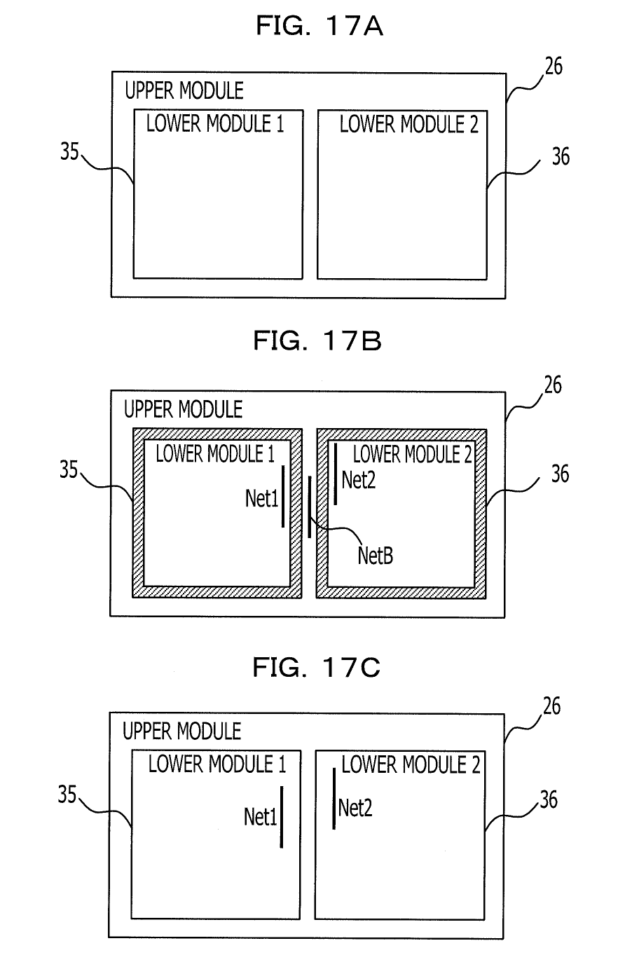

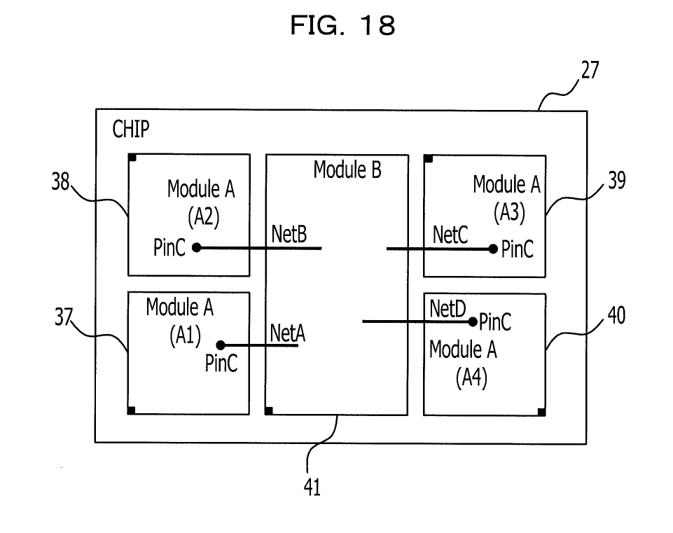

If there exists information regarding upper layer wiring connected to a terminal in the lower module, then layout verifications are conducted by treating that wiring as being connected, via the terminal, to wiring inside the lower module leading to that terminal. This situation is illustrated in FIG. 16. In FIG. 16, Net1 is wiring inside the lower module 30, and is connected to “NetC.PinC” via the terminal PinC in the lower module 30, wherein “NetC.PinC” is information regarding wiring that has been flattened from the upper layer.

While the placement, wiring, and other layout processes for the lower module 30 are being conducted, “NetC.PinC” is simply treated as a prohibited wiring region. However, during layout verification, “NetC.PinC” is treated as a series of wiring connected to the internal Net1 via the terminal PinC. In other words, during layout verification, the Net1 inside the lower module is treated as new wiring connected to “NetC.PinC”, and layout verifications are conducted by attaching a separate, unique net name that is different from Net1. For example, the separate, unique net name may be “Net1.NetC.PinC” or “NetX”.

In doing so, any errors occurring at the contact point (i.e., the terminal PinC portion) between the prohibited wiring region at the terminal portion (NetC.PinC) and the internal wiring Net1 are treated as pseudo-errors, and special processing such as re-verification during the upper layout verification becomes unnecessary. Furthermore, when verifying the layout of the lower module, it becomes possible to make detailed checks of cross-talk noise influence, for example, in a way that also takes into account the upper layer wiring.

Meanwhile, in an embodiment, when a lower module is to be used at multiple locations, information regarding the upper layer wiring at the multiple locations is flattened into a single lower module layout database. Since layout checks are obviously not required between the upper layer wiring at separate locations, the lower module layout verification is configured such that the wiring attribute information contained in the database is checked, and verifications are not conducted between sets of upper layer wiring. Layout verifications among the upper layer wiring may be conducted during the layout verification for the upper layer.

In the timing verifications in S175, values such as wiring capacitance and wiring resistance are extracted from a lower module that has undergone placement and layout design. With these values, wiring and cell delay values are computed, and the computed delay values are then used to conduct timing verifications for determining whether or not the circuit can operate normally at a predetermined frequency. At this point, the upper layer wiring data contained in the lower module layout database may be excluded from the extraction of capacitance or other values. In contrast, the extraction of capacitance or other values may be conducted while also taking into account the upper layer wiring, and the wiring delay or other properties may be computed. If delay calculations are conducted while also taking into account the upper layer wiring information during the lower module timing verifications, then it becomes possible to conduct the lower module timing verifications with higher precision.

Once the detailed design of the lower module layout in S126, S127 to S128 of FIG. 9 is completed, the upper module containing the respective lower modules is laid out. At this point, it is preferable to lay out the upper module while taking into account the wiring conditions near the boundaries inside the respective lower modules for which layout design has been completed. Consequently, in S129 of FIG. 9, information is extracted regarding the wiring at the module boundaries inside the respective lower modules for which layout design has been completed. The details of this extraction process is similar that of the process described with FIG. 10, and thus further description thereof is herein omitted.

The information regarding wiring near the module boundaries inside respective lower modules that is extracted in S129 of FIG. 9 is set as prohibited wiring information when designing the layout of the upper module. The layout of the upper module is then designed (S130). At this point, it is also preferable to extract information regarding the wiring inside lower modules that make use of wiring layers used by upper module wiring processes, as well as information regarding the wiring inside lower modules that may possibly produce cross-talk or otherwise influence wiring in the upper module. In doing so, when laying out the upper module it becomes possible to design the layout of the upper module while taking into account the wiring conditions near the boundaries of lower modules contained in the upper module.

When designing the upper module in S130 of FIG. 9, the designing of the upper module wiring might have already been completed at an earlier stage, such as in S103 of FIG. 2, for example. In such cases, the designing of the upper module may be omitted, and the process may proceed to the upper module evaluation (S131).

In the upper module evaluation in S131 of FIG. 9, the design results from the respective lower modules are used to conduct verifications such as design rule checks and cross-talk noise verifications. In addition, upper module timing verifications may also be conducted together with the layout verifications.

As described earlier, when designing a hierarchical layout in the present invention, the layout can be designed while taking into account wiring conditions in the upper layer or in adjacent lower modules near the boundaries of a given lower module. For this reason, processing to provide a ring-shaped prohibited wiring region surrounding the lower module, for example, becomes unnecessary, and it becomes possible to realize high densities. In addition, when designing the layout of a lower module, it becomes possible to design the layout while also taking into account wiring in the upper layer or inside adjacent modules. At this point, if a lower module is being used at multiple locations, then it becomes possible to design the layout of the lower module while taking into account the wiring conditions in the upper layer and inside adjacent modules near the multiple locations of the lower module.

Furthermore, according to the present invention, when verifying the layout of a lower module, it becomes possible to verify the layout while taking into account upper layer wiring conditions and wiring conditions inside adjacent modules. At this point, it becomes possible to verify the layout while taking into account the upper layer wiring conditions near a lower module used at multiple locations. In addition, during layout verification, the layout is verified by treating upper layer wiring connected to a lower module terminal as wiring connected to wiring inside the lower module via the terminal. In doing so, it becomes possible to favorably verify the layout while taking into account upper layer wiring connected to terminals. Consequently, layout design problems that would only be discovered during the final, overall verification of the upper module with the technology of the related art can be dissolved and addressed at an early stage. As a result, it becomes possible to shorten the layout design time.

A method includes determining whether information of module layout influences another module, identifying respective placement locations as extraction targets among modules and transferring (translating) an upper layer wiring coordinate information to coordinates of lower module(s). A method implemented via a computer includes extracting information regarding an upper layer wiring near respective placement locations, temporarily setting prohibited wiring regions in a layout database based on information of the upper layer wiring extracted and implementing layout of the lower module using the prohibited wiring regions that have been set.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A layout design apparatus that designs a layout of a semiconductor integrated circuit having a plurality of layers, the apparatus comprising:
an extractor configured to extract, when given a lower module used at multiple locations inside an upper module, information regarding an upper layer wiring near respective placement locations where the lower module is placed; and
a layout design unit configured to lay out the lower module by setting prohibited wiring region in a layout database based on information regarding the upper layer wiring extracted from the multiple locations, and
wherein the prohibited wiring regions are specific regions where wiring process is prohibited therein, and
the layout database is data for laying out the lower module.

2. The layout design apparatus according to claim 1, wherein the extractor extracts information regarding a lower module wiring near lower module boundaries in each wiring layer inside all lower modules contained in the upper module,
the extracted information regarding wiring near the boundaries inside each lower module is extracted together with upper module wiring information as information regarding upper layer wiring information near the respective placement locations where the lower module to be laid out is placed, and
the extracted upper layer wiring information is set as prohibited wiring regions when designing the layout of the lower module.

3. The layout design apparatus according to claim 2, wherein when extracting information regarding wiring near the module boundaries in each wiring layer inside lower modules,
the information is extracted as wiring information near the module boundaries inside a lower module, the information is contained inside a region extending inward from the lower module boundary frame by an amount equal to a maximum lower layer spacing which is a maximum wiring distance among inter-wiring distances required as spacing between wiring patterns existing in a wiring layer of the lower module.

4. The layout design apparatus according to claim 1, wherein when extracting information regarding the upper layer wiring near the respective placement locations where the lower module is placed,
the information is extracted as upper layer wiring information near the lower module, the information is contained inside a region extending inward from an enclosing frame set at an outward position separated from the lower module boundary frame by an amount equal to a maximum upper layer spacing which is a maximum wiring distance among inter-wiring distances required as spacing between wiring patterns existing in respective wiring layers in the upper layer of the lower module.

5. The layout design apparatus according to claim 1, wherein the layout of the lower module is verified by taking information regarding an upper layer wiring connected with a terminal in the lower module to be laid out, and treating the wiring indicated as wiring connected with wiring inside the lower module that is connected with that terminal.

6. The layout design apparatus according to claim 1, wherein the layout of the lower module is verified by taking information regarding an upper layer wiring near the lower module that is not connected with a terminal in the lower module to be laid out, and treating the wiring indicated as wiring inside the lower module.

7. The layout design apparatus according to claim 5, wherein when verifying the layout of the lower module to be laid out, determination is made as to whether wiring inside the lower module satisfies predetermined layout design rules with respect to each other, and in addition, whether the upper layer wiring information treated as wiring inside the lower module satisfies predetermined layout design rules with respect to the wiring inside the lower module.

8. The layout design apparatus according to claim 5, wherein when verifying the layout of the lower module to be laid out, layout verifications are not conducted between respective upper layer wiring information treated as wiring inside the lower module.

9. The layout design apparatus according to claim 1, wherein after laying out the lower module, information regarding wiring near the module boundaries inside the laid-out lower module is extracted, and the layout of the upper layer is designed by setting the extracted wiring information as prohibited wiring regions in the upper layer layout design.

10. A layout design method for designing a layout of a semiconductor integrated circuit having a plurality of layers, the method comprising:
extracting information regarding an upper layer wiring near respective placement locations where a lower module which is used at multiple locations inside the upper module is placed;
setting prohibited wiring regions in a layout database based on the information of the upper layer wiring extracted from the multiple locations, the prohibited wiring regions are specific regions that prohibit wiring processes therein, and the layout database is data for laying out the lower module; and
laying out the lower module by using the prohibited wiring regions set in the prohibited wiring region.

11. The layout design method according to claim 10, comprising:
verifying the layout of the lower module after laying out the lower module, and
wherein the layout of the lower module is verified by treating the extracted upper layer wiring information as wiring inside the laid-out lower module, and determining whether the lower module layout results satisfy predetermined layout design rules.

12. A computer-readable recording medium storing a layout design program for designing a layout of a semiconductor integrated circuit having a plurality of layers, the layout design program causing the computer to execute an operation, comprising:
extracting information regarding an upper layer wiring near respective placement locations where a lower module is placed when the lower module is used at multiple locations inside the upper module;
setting prohibited wiring regions in a layout database based on information of the upper layer wiring extracted from the multiple locations, and
wherein the prohibited wiring regions are specific regions that prohibit wiring processes therein, and the layout database is data for laying out the lower module; and
laying out the lower module by using the prohibited wiring regions that have been set.
